(19) United States
(12) Patent Application Publication
(10) Pub. No.: US 2023/0152508 A1
(43) Pub. Date: May 18, 2023

(54) LIGHT GENERATING DEVICE

(71) Applicant: SIGNIFY HOLDING B.V., EINDHOVEN (NL)

(72) Inventors: MICHEL CORNELIS JOSEPHUS MARIE VISSENBERG, ROERMOND (NL); OLEXANDR VALENTYNOVYCH VDOVIN, MAARHEEZE (NL)

(21) Appl. No.: 17/802,954

(22) PCT Filed: Feb. 19, 2021
(86) PCT No.: PCT/EP2021/054144

§ 371 Date: Aug. 28, 2022

(30) Foreign Application Priority Data
Feb. 27, 2020 (WO) 20159695.4

(51) Int. Cl. F21V 8/00

(52) U.S. Cl. CPC G02B 6/0045; G02B 6/0041; G02B 6/0036

(57) ABSTRACT

The invention provides a light generating device (100) comprising a light source (10) and a sheet-like light guide (200), wherein: —the light source (10) is configured to generate visible light (11); —the sheet-like light guide (200) has a first edge (201), configured in a light receiving relationship with the light source (10); wherein the sheet-like light guide (200) comprises light outcoupling structures (290); wherein the sheet-like light guide (200) and the light source (10) are configured such that part of the light source light (11) propagates through the sheet-like light guide (200), and at least part of the light propagating through the sheet-like light guide (200) escapes from the sheet-like light guide (200) via the light outcoupling structures (290); —the sheet-like light guide (200) comprises a first part (270) having a first tangential (T1) in a second plane (P2) perpendicular to a first plane (P1), wherein the first tangential (T1) has a first angle (α1) with the first plane (P1); —the sheet-like light guide (200) comprises a second part (280) having a second tangential (T2) in the second plane (P2), wherein the second tangential (T2) has a second angle (α2) with the first plane (P1); wherein the second part (280) comprises the light outcoupling structures (290); and −60°≤α1≤90°, 0°≤α2≤60°, and α1>α2.

### FIELD OF THE INVENTION

The invention relates to a light generating device and to a luminaire comprising such light generating device.

### BACKGROUND OF THE INVENTION

Discomfort glare is known in the art. US20150373806, for instance, describes that discomfort glare is a feeling of discomfort caused by working under luminaires which are experienced as too bright, for example due to too bright light or too sharp transitions between dark and light areas in the space of the workplace. US20150373806 proposes a lighting device comprising (i) at least one first light source adapted to issue a first beam during operation of the first light source, (ii) at least one second light source adapted to issue a second beam during operation of the second light source, and in dependence on dim levels of the respective light sources, said first and said second light source together are adapted to issue light with a variable total light flux and variable illumination levels, (iii) at a mutually equal light flux of the first beam and the second beam, the first beam and the second beam have a respective glare level, the glare level of the second beam being lower than the glare level of the first beam, and (iv) at least one programmed controller which, during operation, is configured to moderate said dim levels in a range of illumination levels; wherein the range of illumination levels comprises a first illumination level range and a second, higher, illumination level range, and in that in the second, higher, illumination level range a ratio of the dim levels is configured to increase with increasing total light flux, and wherein the at least one programmed controller is configured to moderate the dim levels such that in the first illumination level range the increase of the light flux of the first beam is higher than the increase of the second beam.

### SUMMARY OF THE INVENTION

Fluorescent tubes have been very successful in office lighting applications and other types of lighting before the LED revolution took place, due to the cost, form factor, optical efficiency, beam shape and life time. TL tubes exist in various thicknesses, color spectra and lengths, usually in whole foot sections. After LEDs overtook the market, the TLED was introduced, which is in practice a diffuse plastic or glass tube with a LED board and possibly optics inside. For office compliance, additional beam shaping is required, because both TL tubes and TLED tubes emit light over large angles, which causes glare. Usually, this is done with an armature consisting of lamellae or other kinds of additional optics, which increases the size, costs and obtrusiveness of the luminaire.

For lighting, also light guides may be used. Light guides may be used in both indoor and outdoor lighting luminaires. They may allow for a slim design and/or a soft appearance of the source (diffuse, evenly distributed light without visible LEDs). Amongst others, it appears that a soft appearance may be obtained for luminaires that have a diffuse (Lambertian-like) intensity distribution. In that case, a diffuser sheet may be applied at the exit window. Alternatively, the light extraction from the guide may be done with scattering features (paint dots, surface texture, or bulk scattering particles). For luminaires with a very specific intensity distribution, light guides with specular extraction features (refractive or TIR V-grooves or facets, cone-shaped protrusions or indentations, . . . ) may be used. However, a drawback of specular extraction features is that they may produce a mirror image of the source. As a result, virtual LED sources may be seen when looking at a light guide. This might be considered a positive feature. However, this may not be a suitable way for luminaires to achieve a soft look.

It appears possible to provide a luminaire based on a flat light guide with a weakly scattering extraction feature (paint with forward-scattering particles, or a relatively smooth surface texture, or forward-scattering bulk scattering particles). Because of the scattering, the appearance may be soft (no visible LEDs), but because the scattering is weak, the intensity distribution from the light guide appears to be extremely batwing-shaped. This extreme batwing shape might be used for the uplighting part of the intensity. The downlighting part may be covered by a special beam shaping foil that bends the two intensity peaks towards the normal of the light guide plane. The downward intensity distribution may be shaped such that the luminaire may provide an even illumination of the room while at the same time the glare is limited (not too much light at large angles with respect to the vertical orientation). Such a distribution can also be obtained by other beam shaping optical plates or foils (like micro lens optics plates). This downward beam may also be produced without additional beam shaping plate, but then specular extraction features may be required and the soft appearance is lost.

Hence, there appears to be a desire for a light guide having a downward intensity distribution suitable for indoor lighting and having a soft appearance (i.e. no specular extraction features). Hence, it is an aspect of the invention to provide an alternative light generating device or luminaire or office lighting system, which preferably further at least partly obviates one or more of above-described drawbacks. The present invention may have as object to overcome or ameliorate at least one of the disadvantages of the prior art, or to provide a useful alternative. Amongst others, the invention proposes a luminaire based on a curved light guide that may contain segments with a close-to-vertical orientation and segments with a close-to-horizontal orientation. The light guide may have weak-scattering extraction features, i.e. paint, surface texture, or bulk scattering particles that may have a strongly forward scattering effect (at a scattering event, the light ray may essentially only show slight deviations from the specular direction of less than 5, preferably less than 1°). To generate a downward intensity suitable for indoor lighting, the light extraction may be concentrated in the light guide segments with a close-to-vertical orientation. In specific embodiments, light extraction in the other segments may be limited to a decorative glow or to a luminance value between 500-1000 cd/m² (this may bright enough to be considered a part of a light source, but essentially without the risk of causing glare).

Hence, in a first aspect the invention provides a light generating device (“device” or “lighting device”) comprising a light source and a sheet-like light guide. Especially, the light source is configured to generate visible light. Further, the sheet-like light guide has a first edge, configured in a light receiving relationship with the light source. Especially, the sheet-like light guide comprises light outcoupling structures. In specific embodiments, the sheet-like light guide and the light source are configured such that part of the light source light propagates (due to total internal reflection) through the sheet-like light guide, and at least part of the light propagating through the sheet-like light guide escapes from the sheet-like light guide, especially via the light outcoupling structures. In embodiments, the sheet-like light guide comprises a first part (or “first segment”) having a first tangential (T1) in a second plane (P2) perpendicular to a first plane (P1), wherein the first tangential (T1) has a first angle (α1) with the first plane (P1). Further, in embodiments the sheet-like light guide comprises a second part (or “second segment”) having a second tangential (T2) in the second plane (P2) (perpendicular to the first plane (P1), wherein the second tangential (T2) has a second angle (α2) with the first plane (P1). In specific embodiments, the second part comprises the light outcoupling structures. Further, especially in embodiments 60°≤α1≤90°, such as 60°≤α1≤90° or stated otherwise 60°≤|α1|≤90° such as 60°<|α1|≤90°. Alternatively or additionally, in specific embodiments −60°≤α2≤60°, or stated otherwise 0°≤α2≤60°, 0°≤|α2|≤60°, such as −45°≤α2≤45°, 0°≤α2≤45° or 0°≤|α2|≤45°. Especially, in embodiments α1>α2. Particularly, only the second part comprises the light outcoupling structures, for example only the whole second part comprises the light outcoupling structures. Typically, at any position along the second part it applies that −60°≤α2≤60°, or stated otherwise 0°≤α2≤60°, 0°≤|α2|≤60°, such as −45°≤α2≤45°, 0°≤α2≤45° or 0°≤|α2|≤45°. Hence, especially the invention provides in embodiments a light generating device comprising a light source and a sheet-like light guide, wherein: (i) the light source is configured to generate visible light; (ii) the sheet-like light guide has a first edge, configured in a light receiving relationship with the light source; wherein the sheet-like light guide comprises light outcoupling structures; wherein the sheet-like light guide and the light source are configured such that part of the light source light propagates through the sheet-like light guide, and at least part of the light propagating through the sheet-like light guide escapes from the sheet-like light guide via the light outcoupling structures; (iii) the sheet-like light guide comprises a first part having a first tangential (T1) in a second plane (P2) perpendicular to a first plane (P1), wherein the first tangential (T1) has a first angle (α1) with the first plane (P1); (iv) the sheet-like light guide comprises a second part having a second tangential (T2) in the second plane (P2) (perpendicular to the first plane (P1)), wherein the second tangential (T2) has a second angle (α2) with the first plane (P1); wherein the second part comprises the light outcoupling structures; (v) 60°≤α1≤90°, such as 60°<α1≤90° or stated otherwise 60°≤|α1|≤90° such as 60°≤|α1|≤90, and −60°<α2≤60°, or stated otherwise 0°≤α2<60°, 0°≤|α2|≤60°, such as −45°≤α2≤45°, 0°≤α2≤45° or 0°≤|α2|≤45°, and especially α1>α2. Especially, the first tangential and the second tangential are tangential lines. Particularly, only the second part comprises the light outcoupling structures, for example only the whole second part comprises the light outcoupling structures, Typically, at any position along the second part it applies that −60°≤α2≤60°, or stated otherwise 0°≤α2≤60°, 0°≤|α2|≤60°, such as −45°≤α2≤45°, 0°≤α2≤45° or 0°≤|α2|≤45°.

With such sheet-like light guide, beam shaping may be done without any additional optical element and/or without losing the soft appearance of the light guide. Such light generating device may be relatively easily produced and may in an elegant way provide a low or no glare light generating device, e.g. suitable for office lighting. Further, such light generating device may be used as TLED, which is also useful for office lighting. The invention, however, is not limited to office lighting. Yet, further such light generating device does essentially not need additional layers or optics to provide the desired light distribution.

As indicate above, the light generating device comprises a light source. Especially, the light source is configured to generate visible light. The term “light source” may refer to a semiconductor light-emitting device, such as a light emitting diode (LEDs), a resonant cavity light emitting diode (RCLED), a vertical cavity laser diode (VCSELs), an edge emitting laser, etc. In a specific embodiment, the light source comprises a solid state light source (such as a LED or laser diode). In an embodiment, the light source comprises a LED (light emitting diode). The term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate. In embodiments, a COB is a multi LED chip configured together as a single lighting module. The term “light source” may also relate to a plurality of light sources, such as 2-2000 solid state light sources. The light generated by the light source may be white light or colored light. The term white light herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL (black body locus), especially within about 10 SDCM from the BBL, even more especially within about 5 SDCM from the BBL. In an embodiment, the light source may also provide light source light having a correlated color temperature (CCT) between about 5000 and 20000 K, e.g. direct phosphor converted LEDs (blue light emitting diode with thin layer of phosphor for e.g. obtaining of 10000 K). Hence, in a specific embodiment the light source is configured to provide light source light with a correlated color temperature in the range of 5000-20000 K, even more especially in the range of 6000-20000 K, such as 8000-20000 K. An advantage of the relative high color temperature may be that there may be a relatively high blue component in the light source light.

When more than one light source is available, it may be possible to control one or more optical properties of the light of the light generating device, such as selected from color point, color temperature, etc. Hence, in embodiments the light generating device may also comprise or be functionally coupled to a control system. The control system may be configured to control the optical properties of the light of the light generating device, such as one or more of intensity, color point, color temperature, etc., as function of one or more of user input, a sensor, and a time signal (such as time).

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface. The system, or apparatus, or device may execute an action in a “mode” or “operation mode” or “mode of operation”. Likewise, in a method an action or stage, or step may be executed in a “mode” or “operation mode” or “mode of operation”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed. However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

As indicated above, the light generating device further especially comprises in embodiments a sheet-like light guide, wherein the sheet-like light guide has a first edge, configured in a light receiving relationship with the light source.

At least one of the terminal edges of the curved light guide is configured in a light receiving relationship with the light source. Hence, the light source and at least one of the terminal edges is radiationally coupled. The term “radiationally coupled” or “optically coupled” may especially mean that a light source and another item or material are associated with each other so that at least part of the radiation emitted by the light source is received by item or material. In other word, the item or material are configured in a light-receiving relationship with the light source. At least part of the radiation of the light source will be received by the item or material. This may in embodiments be directly, such as the item or material in physical contact with the (light emitting surface of the) light source. This may in embodiments be via a medium, like air, a gas, or a liquid or solid light guiding material. In embodiments, also one or more optics, like a lens, a reflector, an optical filter, may be configured in the optical path between light source and item or material. In specific embodiments, both terminal edges of the curved light guide may be configured in a light receiving relationship with the light source.

The light guide is especially used to couple light source light from the light source into the light guide and to couple at least part of the light out of the light guide. Hence, part of the incoupled light source light may not be coupled out due to total internal reflection, but part may be coupled out via the part with outcoupling structures. Hence, the light guide should be relatively transmissive for the light source light and have a relatively low scattering (at least the first part). Hence, the light guide may comprise essentially transparent material. Suitable light transmissive materials may be selected from the group consisting of a transmissive organic material, such as selected from the group consisting of PE (polyethylene), PP (polypropylene), PEN (polyethylene napthalate), PC (polycarbonate), polymethylacrylate (PMA), polymethylmethacrylate (PMMA) (Plexiglas or Perspex), cellulose acetate butyrate (CAB), polyvinylchloride (PVC), polyethylene terephthalate (PET), including in an embodiment (PETG) (glycol modified polyethylene terephthalate), PDMS (polydimethylsiloxane), and COC (cyclo olefin copolymer). Especially, the light transmissive material may comprise an aromatic polyester, or a copolymer thereof, such as e.g. polycarbonate (PC), poly (methyl)methacrylate (P(M)MA), polyglycolide or polyglycolic acid (PGA), polylactic acid (PLA), polycaprolactone (PCL), polyethylene adipate (PEA), polyhydroxy alkanoate (PHA), polyhydroxy butyrate (PHB), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN); especially, the light transmissive material may comprise polyethylene terephthalate (PET). Hence, the light transmissive material is especially a polymeric light transmissive material. In embodiments, the light transmissive material may comprise a silicone, such as in embodiments dimethyl silicone or methylphenyl silicone, etc. The light transmissive material of the sheet-like light guide is herein also indicated as “light guiding material”.

Hence, the sheet-like light guide and the light source may especially be configured such that part of the light source light propagates (due to total internal reflection) through the sheet-like light guide. Hence, it may be useful to apply a light source that generate light source light that is not collimated and/or not to use optics downstream of the light source and upstream of the first edge(configured in a light receiving relationship with the light source) that collimates the light source light. In embodiments, the light source light that irradiates the first edge is divergent. In yet other embodiments, downstream of the light source and upstream of the first edge, an optical element may be configured which may (pre)collimate the light source light. In this way, Fresnel losses may be reduced. Alternatively or additionally, in embodiments a (light source) light incoupling element may be available configured to widen the incoming beam of light source light in the plane of the light guide. This may especially be useful for improving light mixing (within the light guide) of neighboring light sources, such as LEDs.

As indicated above, the sheet-like light guide comprises light outcoupling structures. Especially, only part of the sheet-like light guide, such as only the second part, comprises such outcoupling structures. Hence, over part of the sheet-like light guide light outcoupling may be relatively low (low luminance) and over another part of the sheet-like light guide, outcoupling may be larger (high(er) luminance). In this way, a desired beam shape of the device light may be provided. The device light may especially comprise the light source light that escapes from the sheet-like light guide.

Would there be no outcoupling structures, a substantial part, if not essentially all of the light source light may be captured in the sheet-like light guide, and may only escape from the edge, such as the first edge. Due to the outcoupling structures, at least part of the light source may escape from the sheet-like light guide. Hence, especially at least part of the light propagating through the sheet-like light guide escapes from the sheet-like light guide via the light outcoupling structures.

As indicated above, the sheet-like light guide may have a part that is more horizontal than vertical and a part that is more vertical than horizontal. Especially, the latter part may comprise the outcoupling structures, whereas the former part may essentially not comprise outcoupling structures.

Hence, in embodiments the sheet-like light guide may comprise a first part having a first tangential (T1) in a second plane (P2) perpendicular to a first plane (P1), wherein the first tangential (T1) has a first angle (α1) with the first plane (P1). This may e.g. be—under operational conditions—be the part that is more horizontal than vertical. Further, in embodiments the sheet-like light guide may comprise a second part having a second tangential (T2) in the second plane (P2) (perpendicular to the first plane (P1)), wherein the second tangential (T2) has a second angle (α2) with the first plane (P1). This may e.g. be—under operational conditions—be the part that is more vertical than horizontal. Hence, especially 60λ≤α1≤90°, 0°≤α2≤60°, and α1>α2. Further, the second part comprises the light outcoupling structures.

The term “first part” may also refer to a plurality of first parts. In embodiments, the term “first part” may refer to two first parts that are mirror images of each other relative to mirror plane. Alternatively or additionally, the term “first part” may refer to two parts between which a second part is configured. The first part may be planar. Alternatively, the first part may be 1D curved. In embodiments, the first part may be 2D curved. The first part may be elongated, with a length larger than a height. When the first part would be planar, there may be a single first tangent. When the first part is curved, there may be a plurality of first tangents (dependent whether the curvature is in the second plane). Especially, for all first tangents may apply the one or more embodiments of the herein described conditions in relation to the first angle. Or in other words, at any position along the first part first tangents to the first part in the second plane comply with one or more of the herein described embodiments for the first tangent, i.e. 60λ≤α1≤90° (and α1>α2).

The term “second part” may also refer to a plurality of second parts. In embodiments, the term “second part” may refer to two second parts that are mirror images of each other relative to mirror plane. In embodiments, the second part may be configured between two first parts. The second part may be planar. Alternatively, the second part may be 1D curved. In embodiments, the second part may be 2D curved. The second part may be elongated, with a length larger than a height. When the second part would be planar, there may be a single second tangent. When the second part is curved, there may be a plurality of second tangents (dependent whether the curvature is in the second plane). Especially, for all second tangents may apply the one or more embodiments of the herein described conditions in relation to the second angle. Or in other words, at any position along the second part second tangents to the second part in the second plane comply with one or more of the herein described embodiments for the second tangent, i.e. 0°≤α2≤60° (and α1>α2).

As indicated above, embodiments of the conditions are one or more of (i) 60°≤α1≤90°, (ii) 0°≤α2≤60°, and (iii) α1>α2.

Especially, in embodiments there may be one or more first tangents having a first angle selected from 70°≤α1≤90°. In specific embodiments, there may be at least a first tangent having a first angle of 90°. In embodiments this may imply—during operation of the light generating device—a horizontally oriented first tangent.

Further, especially, there may be one or more second tangents having a second angle selected from 0°≤α2≤45°. In specific embodiments, there may be at least a second tangent having a second angle selected from 0°≤α2≤25°. In yet even more specific embodiments, there may be at least a second tangent having a second angle of 0°. In embodiments this may imply—during operation of the light generating device—a vertical oriented second tangent.

The fact that the first part and the second part may have different angles in the second plane may imply that the parts are configured under an angle, like two parts having a mutual angle. Especially, the first part and the second part merge in a smooth way and may be connected via (end parts that form) a bend (or turn). Especially, the sheet-like light guide is not planar, but has a 3D shape which may in embodiments be obtainable by bending the sheet-like light guide into the desired 3D shape. Even though the sheet-like light guide may also be obtainable by extrusion, its shape may in embodiments be relatively smooth, with overall angles between different parts equal to or smaller than about 10°. In specific embodiments, a radius of curvature of a bend (within a part or connecting two parts) may be substantially larger than the thickness of the light guide (such as at least about 7 times, or even at least about 10 times, such as at least about 15 times, like 20 times or more in embodiments). Hence, a radius of curvature of a bend between different parts (or within a part), such as especially the first part and the second part, may be substantially larger than the thickness of the light guide, such as at least 7 times, like at least 10 times, or even at least about 15 times, such as at least about 20 times. In this way, total internal reflection is essentially guaranteed (except where TIR is diminished on purpose due to the light outcoupling structures).

Especially, in embodiments a first part is configured downstream of a second part. Hence, light source light may propagate through the second part to the first part. Especially, in embodiments the power (Watt) of the light that enters the second part may be reduced with at least 50% before it enters the first part. Even more especially, the reduction of the power of the light may be at least 70%.

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

There may be more than one second part, especially in terms of tangential conditions (see also above). In embodiments where there are more than one second parts, at least one of these may comprise the light outcoupling structures. Would there be a second part that does not comprise light outcoupling structures, such part may have a relatively small contribution to the beam shaping of the device light, like the first part. Hence, the term “second part” especially refers to those part(s) that comply with the herein mentioned angular conditions and which comprise(s) light outcoupling structures. Therefore, especially the first part or the first parts may comprise essentially not light outcoupling structures. In contrast, the second part especially should comprise light outcoupling structures. This second wall part may allow that instead of total internal reflection (TIR) light rays may escape from the light generating device. However, when there are more than one second parts, at least one should comprise light outcoupling structures. Hence, in embodiments at least about 50% of the total power of the light source light that may escape from the light guide escapes from the second wall part, such as especially at least 60% of the total power of the light source light that escapes from the light guide. Hence, at least 50% of the light that enters the light guide may escape via the second wall part, such as at least 60% thereof. Further, in the order of 0-50% (of the light that enters the light guide), such as about 0-40%, like about 5-30%, may escape from other parts than the second wall part. Further, some light may not escape; the overall optical efficiency may in embodiments be about 70-90%, such as about 75-85%, like especially about 80%; such as e.g. 60% via the second wall part and 20% via other wall parts. A value of in total 100% outcoupling would imply that all incoupled light would also be outcoupled; in practice it may be about 70-90%. From the light that escapes from the light guide, at least about 60%, such as at least about 70%, such as about at least 75%, may escape via the second part.

By arranging the outcoupling structures primarily at the second part and not at the first part, a beam shape may be provided that has low or no glare. Hence, surprisingly, with scattering elements a desirable light beam may be shaped. Therefore, in embodiments a light generating device, e.g. for indoor lighting, is provided, which is especially based on a curved light guide shape, that may have a typical indoor lighting distribution and a soft appearance (no visible LEDs) without the need for additional beam shaping optics.

The sheet-like light guide may have a thickness which in embodiments may be in the range of 0.5-5 mm, such as 0.7-3 mm. Especially, the thickness of the sheet-like light guide is essentially uniform over the entire sheet-like light guide. There may be some relatively small variations (see below), but especially the thickness is essentially constant. Herein, the term “sheet-like light guide” as the light guide may have a thickness that is essentially smaller than a length and/or a height of the sheet-like light guide. For instance, a ratio of the thickness of the sheet-like light guide to a square root of the area of a cross-sectional plane of the sheet-like light guide (essentially “its area”) may be equal to or less than 0.2, such as equal to or smaller than 0.1, like equal to or less than 0.05, such as equal to or less than 0.01, or even much lower.

Part of the light source light in the sheet-like light guide may escape from the parts of the sheet-like light guide where essentially no outcoupling structures are available, but this part may be relatively low, such as at maximum about 30%, like at maximum about 25%. Another part of the light source light in the sheet-like light guide may escape from the second part comprising the light outcoupling structures. This part may be relatively large. As indicated above, this may be equal to or more than 60%, such as especially at least about 70% of the power of the light source light that couples out from the sheet-like light guide, such as at least about 75 (see also above). Hence, in embodiments the light source, the sheet-like light guide including the light outcoupling structures are selected such, that a first luminance L1 from the first part is equal to or lower than 1000 cd/m², when viewed from any direction, and a second luminance L2 from the second part is at least 2000 cd/m² (when viewed from least one viewing direction). The light exiting from the part with outcoupling element may be highly directional, so the luminance may strongly depend on the viewing direction. Hence, especially the luminance of the second part may be similar to the rest of the light guide for viewing directions outside of the main beam (“glowing”) and a high luminance inside the main beam (typically varying from a few thousand up to a few ten thousands or even hundred thousand(s) cd/m² locally, viewed from the peak intensity direction. Especially, the first luminance L1 from the first part may be selected from the range of 500-1000 cd/m². Likewise, this may apply to second parts essentially without light outcoupling structures. In this way, the entire sheet-like light guide may provide light, but the second part(s) comprising light outcoupling structures may have a substantially higher luminance.

The second part comprising the light outcoupling structures may comprise a substantial part of the total volume of the sheet-like light guide. The term volume or total light guide volume refers to the volume defined by the material of the sheet-like light guide per se. Hence, it does not refer to an enclosed volume but may essentially only refer to the light guiding material. However, especially the second part comprising the light outcoupling structures does not comprise the entire volume of the sheet-like light guide, but only part thereof. Hence, in embodiments the sheet-like light guide has a total light guide volume V₀, wherein the first part has a first volume V₁, wherein the second part has a second volume V₂, wherein each of the first part and the second part have a volume of at least 20% of the total light guide volume V₀. Here, again the term “second part” especially refer to the second part comprising the light outcoupling structures.

As indicated above, the sheet-like light guide comprises light guiding material, such as e.g. PMMA, PC, PET, etc. Light guiding material comprised by a second part may comprise particulate material as light outcoupling structures. Such particulate material may be embedded in the light guiding material. It appears that for very small particles, light is strongly scattered in all directions, without a preference for the forward or backward direction. For larger particles, the light has a tendency to be scattered more in the forward direction (the initial direction of the light before scattering). Hence, in embodiments the light outcoupling structures comprise particles, wherein the particles are embedded in the second part of the sheet-like light guide, wherein the particles have volume averaged particle sizes selected from the range of 0.1-500 μm, especially selected from the range of 1.5-200 μm. In embodiments, the particles have volume averaged particle sizes selected from the range of at least 0.5 μm, even more especially at least 1 μm, like at least 2 μm. The smaller the particles, the less the forward scattering may be. Especially, at least 80 vol. % of the particles, even more especially at least 90 vol. % of the particles have a particle size of at least 1 μm, like at least 2 μm. Herein, the term “particle size” may especially refer to the spherical equivalent diameter (or “equivalent spherical diameter”). The term “equivalent spherical diameter” (or ESD) of an (irregularly) shaped object is the diameter of a sphere of equivalent volume. However, especially, the particles used may be relatively spherical. Especially, a longest dimension and a smallest dimension may have an aspect ratio not larger than 5, such as not larger than 2.5. When all aspect ratios are 1, the particle is essentially spherical.

In embodiments, wherein the light outcoupling structures comprise particles, wherein the particles are embedded in the second part of the sheet-like light guide (200), especially the particles may have volume averaged particle sizes (D1) selected from the range of 1.5-200 μm. Here, the size (D1) may especially refer to the volume-based particle size which equals the diameter of a sphere that has the same volume as a given particle.

Further, in specific embodiments, wherein the sheet-like light guide (200) has a light guide thickness d, at least 90 vol. % of the particles (291) may have a particle size (D1) of at maximum 0.1*d. Especially, in embodiments a volume fraction φ of the particles (291) may be selected from the range of 0.1*⅔*D1/d≤rp≤10*⅔*D1/d. The equation “0.1*⅔*D1/d≤φ≤10*⅔*D1/d” may also be rewritten as (0.1)*(⅔)*(D1)/(d)<<(10)*(⅔)*(D1)/(d). This may especially apply for a peaked particle size distribution around D1. Would the distribution be peaked at multiple sizes (a mixture of two or more sizes) or would it be a broad distribution over a size range, this condition may especially hold for the sum of 2*D1/(3*d) values.

Yet, in further embodiments in other parts of the sheet-like light guide (200) than the second part (280), a volume fraction φ of the particles (291) may be equal to or smaller than 0.1*⅔*D1/d, such as equal to or smaller than 0.01*⅔*D1/d. This may be first parts, where outcoupling may be less desired, and/or this may be second parts also having similar second tangentials, but essentially not comprising particles (i.e. at least about 10 times less than in the second part comprising the particulate light outcoupling structures). Again, would the distribution be peaked at multiple sizes (a mixture of two or more sizes) or would it be a broad distribution over a size range, this condition of the volume fraction φ of the particles (291) being equal to or smaller than 0.1*⅔*D1/d (such as equal to or smaller than 0.01*⅔*D1/d) may especially hold for the sum of 2*D1/(3*d) values.

The influence of a difference in index of refraction of the light guiding material and the particles on the beam shaping appears to be relatively small. Good (simulation) results were obtained in embodiments wherein the sheet-like light guide has a first index of refraction n1, wherein the particles have a second index of refraction n2, wherein 0.05≤|n1−n2|≤0.5.

Instead of or in addition to the particulate light outcoupling structures embedded in the light guiding material of the second part, the second part may also have light outcoupling structures at its surface. The sheet-like light guide comprises a first face and a second face. The first face and the second face especially define the thickness of the sheet-like light guide. When the sheet-like light guide has light outcoupling structures at an external face, these may especially be comprised by one of the faces. Hence, in specific embodiments the second face comprises the light outcoupling structures. In embodiments wherein the sheet-like light guide may enclose a (internal) volume, the second face may especially refer to an external face of the sheet-like light guide.

In embodiments, the light outcoupling structures may be comprised by a coating. Alternatively or additionally, the light outcoupling structures may be comprised by a surface of the second part (of the sheet-like light guide). Hence, in embodiments the light outcoupling structures are comprised by a coating or the light outcoupling structures comprise surface structures comprised by the second face. Therefore, such light outcoupling structures may also be indicated as “surface light outcoupling structures”. Hence, in specific embodiments. This coating may comprise either surface structures or volume scattering particles (or optionally both). In embodiments, the coating may be applied to a (curved) light guide which itself is made without essentially any extraction features. Hence, in embodiments the extraction features may be added in a later step by means of the coating. Alternatively, the scattering particles or surface structures may be embedded in the light guiding material of the second part.

Note that in specific embodiments light outcoupling structures may be comprised by a surface of the second part and may be comprised within the volume of the second part.

Especially, the latter outcoupling structures may be a small modulation on the surface (of the second face) of second part. Such modulation may be sinusoidal or sawtooth light, or a combination thereof. Such modulation may comprise elongated structures, pyramidal structures, etc. Hence the surface light outcoupling structures may be 1D modulations, like a 1D corrugated plane, or 2D modulations. Especially, however, an angle of faces of such modulation relative to a cross-sectional plane are equal to or smaller than 10°. Hence, in embodiments the light outcoupling structures are defined by surface variations of the second face of equal to or less than 10°. Even more especially, in embodiments the light outcoupling structures are defined by surface variations of the second face of equal to or less than 5°, such as even more especially equal to or less than 2°. Especially, the surface variations are defined by maximum surface variations of the second face of at least 0.5°, such as at least 1°. The surface variations may be defined with respect to a cross-sectional plane or with respect to a normal to a normal to the surface (such as especially to the first face). Hence, in embodiments maximum surface variations may be equal to or more than 0.5°. Further, each surface variation may comprise a first part that bends away from an average surface and a second part that bends towards the average surface. Here, the angles for the surfaces variations especially refer to the maximum slope of the surface variations structure. Therefore, in embodiments the light guide may have global variations (the curvature of the light guide) and local variations (local deviations from a parallel orientation) on the light guide.

In embodiments, the second part may comprise in the range of 0.5-100 surface variations per cm of the cross-section. Typically, a variation may have a length of the order of A/tan(β) where A is the amplitude of the variation and β the angle the slope. The slope is between 0.5 and 10°, so the variation length may be between 5A and 115A. The thickness of the sheet-like light guide is d. Hence, the amplitude may in embodiments be typically between 0.05*d−0.2*d, which is substantially much smaller than d but also not too small. Hence, in embodiments the number of variations along a length d may vary between about 0.25 (i.e. 0.05×5) and 23 (i.e. 0.2×115). Hence, in embodiments the second part may comprise 0.25-25 surface variations over a length d. In an embodiment that was simulated, the thickness d was about 3 mm. Hence, the range would then be in the order of about 0.8-83 surface variations over a cm. Therefore, the second part may comprise in the range of 0.5-100 surface variations per cm of the cross-section.

In specific embodiments, 5-25% of a surface area of the second face may comprise the light outcoupling structures. Further, in specific embodiments the second part may have a second average outcoupling structure density or second average surface variation density C2, wherein the first part has a first average outcoupling structure density or first average surface variation density C1, wherein for ratio C1/C2 applies that 0<C1/C2≤0.1, such as 0.0001≤C1/C2≤0.1. By choosing a specific ratio, in a relatively easy and attractive manner the ratio of the light coupled out from the first part respectively from the second part is set. Optionally, hereby also the beam shape can be set.

In specific embodiments the light generating device, especially the sheet-like light guide may have an essentially circular cross-section in a plane perpendicular to the first plane and the second plane. Hence, in specific embodiments the sheet-like light guide has a body axis (BA) around which the sheet-like light guide is rotational symmetrically configured. In this way, a bulb type light generating device may be provided.

In alternative embodiments, such cross-section is not circular but elongated like rectangular, with e.g. an aspect ratio of at least 5, like at least 10. Therefore, in embodiments the sheet-like light guide is elongated, especially in a plane perpendicular to the second plane. Therefore, in embodiments the sheet-like light guide has an elongated shape having the first plane (P1) as plane of symmetry.

In specific embodiments, also further elucidated below, the sheet-like light guide has piriform-like shaped cross-section with the second plane (P2). Especially when the piriform-like shaped sheet-like light guide is elongated, a T-LED type of lamp may be provided. Such light generating device may e.g. replace a T-LED when direction light is desired.

In yet other embodiments, the sheet-like light guide may comprise two (or more) sheet-like light guides, between which there is essentially no TIR. Such two (or more) sheet-like light guides may be configured symmetrically relative to the first plane. Hence, in specific embodiments the light generating device comprises two sheet-like light guides, wherein each sheet-like light guide has a first edge and a second edge, wherein the first edges are closer to each other than to the second edges, and wherein the second edges are configured further away from each other than the first edges are configured from each other, and wherein the first planes (P1) coincide, and wherein the first planes (P1) are planes of symmetry for the two sheet-like light guides.

In yet a further aspect, the invention also provides in embodiments a light generating device comprising a light source and a sheet-like light guide, wherein: (i) the light source is configured to generate visible light; (ii) the sheet-like light guide has a first edge, configured in a light receiving relationship with the light source; wherein the sheet-like light guide comprises light outcoupling structures; wherein the sheet-like light guide and the light source are configured such that part of the light source light propagates through the sheet-like light guide, and at least part of the light propagating through the sheet-like light guide escapes from the sheet-like light guide via the light outcoupling structures; (iii) the sheet-like light guide comprises a light outcoupling part having a light outcoupling part tangential (T2) in the second plane (P2) (perpendicular to the first plane (P1)), wherein the light outcoupling part tangential (T2) has a light outcoupling part angle (α2) with the first plane (P1); wherein the light outcoupling part comprises the light outcoupling structures; and (iv) 0°≤α2≤60°, even more especially 0°≤α2≤40°, like yet even more especially 0°≤α2≤20°. In such embodiments, there is at least a part complying with the conditions for the light outcoupling part angle, comprising the light outcoupling structures, and optionally such embodiments may also comprise other parts also complying with such angle (α2), but not comprising light outcoupling structures. Further, such embodiments may not necessarily comprise parts that comply with the elsewhere described condition of 60°≤α1≤90° (and thus optionally also the condition of α1>α2).

Especially, the sheet-like light guide is a curved light guide, with (at least) a curvature in the second plane.

In specific embodiments, a light generating device with sheet-like light guide and/or the sheet-like light guide per se, are proposed comprising a curved (sheet-like) light guide, like a U-shape or a droplet shape. Especially, the light guide should have a downward intensity distribution suitable for indoor lighting and have a soft appearance (i.e. no specular extraction features).

In specific embodiments, in operation the first plane and the second plane are essentially vertical, such as in embodiments within 80-100°, especially within 85-95°, such as within 88-92°, relative to the earth's surface/horizontal.

In yet a further aspect, the invention provides a luminaire comprising (a) the light generating device as defined herein, and optionally (b) a support for the light generating device. Especially, in embodiments the support and the light generating device are configured for a suspended configuration of the light generating device. The luminaire may further comprise a housing, optical elements, louvres, etc.

In yet a further aspect, the invention also provides a sheet-like light guide as defined herein. Especially, in an aspect the invention provides a sheet-like light guide, wherein in embodiments (i) the sheet-like light guide has a first edge, configurable in a light receiving relationship with a light source configured to generate visible light source light; wherein the sheet-like light guide comprises light outcoupling structures; wherein the sheet-like light guide is transmissive for at least part of the visible light source light of the light source; wherein the light outcoupling structures are configured to facilitate escape of part of the light source light propagating (due to total internal reflection) through the sheet-like light guide; (ii) the sheet-like light guide comprises a first part having a first tangential (T1) in a second plane (P2) perpendicular to a first plane (P1), wherein the first tangential (T1) has a first angle (α1) with the first plane (P1); (iii) the sheet-like light guide comprises a second part having a second tangential (T2) in the second plane (P2) (perpendicular to the first plane (P1)), wherein the second tangential (T2) has a second angle (α2) with the first plane (P1); wherein the second part comprises the light outcoupling structures. Especially, in yet further embodiments 60°≤α1≤90°, 0°≤α2≤60°. Even more especially, α1>α2.

Further specific embodiments are described below.

In embodiments an optical part, close to the shape of a TL tube, is proposed, which acts as a light guide, which includes in embodiments a wedge-like shape, especially to aim light in a preferred direction, such that e.g. office compliancy may be obtained, without the use of additional parts. This may make the luminaire compact, non-obtrusive and cheap. Hence, amongst others the invention provides an office compliant TLED. The tubular LED or “TLED” is a type of LED light source designed to replace fluorescent lamps. The TLED lamp is designed to fit into the fluorescent socket, effectively converting the light fixture from fluorescent to LED.

In embodiments, the invention provides a light generating device comprising a light source and an outcoupling unit comprising an elongated hollow body (“body”, or “hollow body”, or “elongated body”), and a fixation element, wherein: the elongated hollow body is especially defined by a curved light guide (“light guide”), wherein the curved light guide has one or more, especially two, terminal edges, wherein the elongated hollow body has an axis of elongation (EA) and a body height (H), wherein the elongated hollow body has in embodiments a piriform-like shape with a piriform-like shaped cross-section perpendicular to the axis of elongation (EA). The elongated hollow body may have a first end and a second end. Especially, the second end may comprise two terminal edges of the light guide. Especially, the piriform-like shaped elongated hollow body comprises (i) a bulb shaped body part having a first width (W1) perpendicular to the axis of elongation (EA), wherein the bulb shaped body part may define the first end of the elongated hollow body; and (ii) a narrow shaped body part, configured adjacent to the bulb shaped body part, having a second width (W2) perpendicular to the axis of elongation (EA) being smaller than the first width (W1), wherein the narrow shaped body part may comprise the two terminal edges, wherein the narrow shaped body part may especially define the second end of the elongated hollow body. Especially, the first end and the second end define the body height (H).

In embodiments, the light generating device may further comprise a fixation element. Especially, the fixation element may be configured to keep the first terminal edges together. Further, in embodiments the fixation element may have suspension functionality or may be configured to allow such suspension functionality. In this way, the light generating device may be configured in a luminaire wherein the light generating device is configured suspended, such as in office lighting, or the light generating device may be configured suspended to a ceiling, without additional housing.

As indicated above, the invention provides amongst others a light generating device comprising an elongated hollow body, a light source, and optionally a fixation element.

The elongated hollow body may in embodiments have the cross-sectional shape rather similar to a conventional light bulb or to a pear. Hence, the elongated hollow body is herein also indicated as having in embodiments a piriform-like shape with a piriform-like shaped cross-section. The term “piriform-like shape” especially refers to a cross-sectional shape (perpendicular to an axis of elongation). Piriform may thus mean pear-shaped.

The elongated hollow body is indicated as “elongated” as in a direction perpendicular to the cross-section (having in embodiments a piriform-like shape (and in other embodiments essentially having a circular shape), the elongated hollow body is elongated. For instance, assuming a conventional bulb, such bulb may have a symmetry plane. The cross-section of the bulb with the cross-sectional plane provides the piriform-like shape. When elongating this shape along an axis of elongation perpendicular to the cross-sectional plane, the elongated hollow body may be obtained. Hence, the light generating device may have an essentially tubular shape, with in embodiments an essentially piriform-like shape.

Hence, the elongated hollow body may have a length along the axis of elongation or body axis (EA). Further, the cross-section shape may have a height and a width, both in the cross-sectional plane. In embodiments, the height may be constant along the length. The width may also be constant over the length of the elongated hollow body, but varies over the height.

In embodiments, the elongated hollow body may essentially consist of two parts, like a pear, having a bulb-like shaped (larger) part and a more narrow-shaped body part. In a typical hanging configuration, the bulb-like shaped (larger) part will be below (inferior) and the more narrow-shaped body part will be above (superior). Hence, there may be a first width, which may be a largest width, at the bulb shaped body part, and a second width, smaller than the first width, at the narrow shaped body part. In general, in contrast to a purely piriform-shaped element, the narrow part is in embodiments not converging to a point, but may be blunt and/or rectangular, as the second end may (in embodiments) be defined by the edges of a sheet-like or plate-like light guide (see also below). The height of the elongated hollow body may be defined by a terminal part of the bulb-like shaped, indicated as first end, and a terminal part of the narrow-shaped body part, indicated as second end.

The piriform-like shape may relatively easily be obtained by using a sheet-like or plate-like light guide (see also below), of which two terminal edges are brought to each other. Especially when the light guide is flexible, which may in embodiments be the case with a relatively thin light guide of e.g. polymeric material, essentially automatically the piriform like shape may be obtained.

Hence, in embodiments the elongated hollow body may be defined by a curved light guide, wherein the curved light guide has two terminal edges, wherein the elongated hollow body has an axis of elongation (EA) and a body height (H). Especially, in embodiments the elongated hollow body has a piriform-like shape with a piriform-like shaped cross-section perpendicular to the axis of elongation (EA). Further, as indicated above, especially the piriform-like shaped elongated hollow body comprises (i) a bulb shaped body part having a first width (W1) perpendicular to the axis of elongation (EA), wherein the bulb shaped body part defines a first end of the elongated hollow body; and (ii) a narrow shaped body part, configured adjacent to the bulb shaped body part, having a second width (W2) perpendicular to the axis of elongation (EA) being smaller than the first width (W1), wherein the narrow shaped body part comprises the two terminal edges, wherein the narrow shaped body part defines a second end of the elongated hollow body. The body height may in embodiments be in the order of 1.5-100 cm, such as 2-60 cm.

The thickness (at the terminal edges) may in embodiments be chosen to be essentially equal to the width of a solid state light source die, or in other embodiments essentially equal to half of the width of a solid state light source die. In the former embodiments, one of the terminal edges may be configured in a light receiving relationship with the solid state light source; in the latter embodiments both terminal edges may be configured in a light receiving relationship.

In this way, a good, essentially triangular light distribution or droplet shape distribution may be obtained, wherein the intensity is essentially within an angle of about 65° from a normal to the elongated hollow body, even within angle of about 60° from a normal to the elongated hollow body, i.e. beam angles γ (in a plane perpendicular to the body axis) of 130° and 120°, respectively.

As the light guide material may have a low scattering, the mean free path for scattering may be relatively long, such as at least 2 mm, like at least 5 mm, like especially at least 10 mm. Hence, in embodiments the curved light guide and an optional coating thereon have a mean free path (for scattering) of the visible light of at least 5 mm. Amongst others, the mean free path may be determined with a laser and measuring the transmission at at least two different thicknesses of the light transmissive material. Here, the mean free path refers to the light guide material per se, thus in the (virtual) absence of light outcoupling structures, such as particles.

One or more lights sources may provide light source light to a single terminal edge. However, in specific embodiments each light source of the one or more light sources is configured to provide light source light to both terminal edges. Hence, the light source, or in embodiments the plurality of light sources, may radiationally be coupled with both terminal edges. In other words, both terminal edges are configured in a light receiving relationship with the light source, or in embodiments the plurality of light sources.

In addition to the two terminal edges, the light guide may also have two second edges, at the terminal edges of the elongated hollow body respectively. The elongated hollow body may have a body length, which may be defined by these two second edges. In embodiments, light may escape from these second edges. In order to control the light distribution of this light, it may be useful to provide the light source light to the terminal edges via an optical element that shapes the beam, like a lens and/or a collimator. Therefore, in embodiments the light generating device may further comprise a collimator (and/or a lens) configured downstream of the light source and upstream of at least one of the terminal edges. Especially, the collimator may be used to (further) collimate the light source light and thereby influence the light distribution of the light escaping from the light guide.

Alternatively or additionally, at one or more second edges a reflector may be configured. In this way, light that could escape via the one or more second edges is reflected back in the light guide, and may in embodiments escape elsewhere, such as at the reduced thickness part. Hence, in embodiments the elongated hollow body comprises two second edges, wherein the elongated hollow body has a body length (L) parallel to the axis of elongation, wherein the body length (L) is defined by the two second edges, wherein the light generating device further comprises two reflectors configured downstream of the respective second edges.

As indicated above, a plurality of light sources may be applied. These may in embodiments be configured over the length of the terminal edges. Hence, in embodiments the elongated hollow body has a body length (L) parallel to the axis of elongation, wherein the body length (L) is at least as large as the first width (W1) of the bulb shaped body part, wherein the light generating device comprises a light source array comprising a plurality of light sources, wherein the light source array has an array length (L2), wherein the array length (L2) is at least 50% of the body length (L), like in the range of 50-100% of the body length. For instance, at least one solid state light source per cm length of the body length may be provided. In embodiments, the body length is larger than the first width. In yet further embodiments, the body length is at least 2 times, like at least 5 times, such as in the range of 10-1000 times the first width. However, other ratios may also be possible. In embodiments, the body may have a relatively high aspect ratio of body length to body height, such as at least 5, even more especially at least 10, such as in the range of 10-1000.

Therefore, in embodiments the curved light guide comprises a curved plate-like light guide comprising two first terminal edges which are both configured at the second end, wherein the light generating device comprises a plurality of light sources, and wherein the two first terminal edges are configured in a light receiving relationship with the plurality of light sources.

As further indicated above, in embodiments the light generating device may further comprise a fixation element. Especially, the fixation element is configured to keep the first terminal edges together. The fixation element may comprise one or more of a mechanical fixation and a chemical fixation. For instance, the fixation element may comprise a bolt and nut, a screw, a clamp, or another means that may keep the terminal edges close to each other, or even press together.

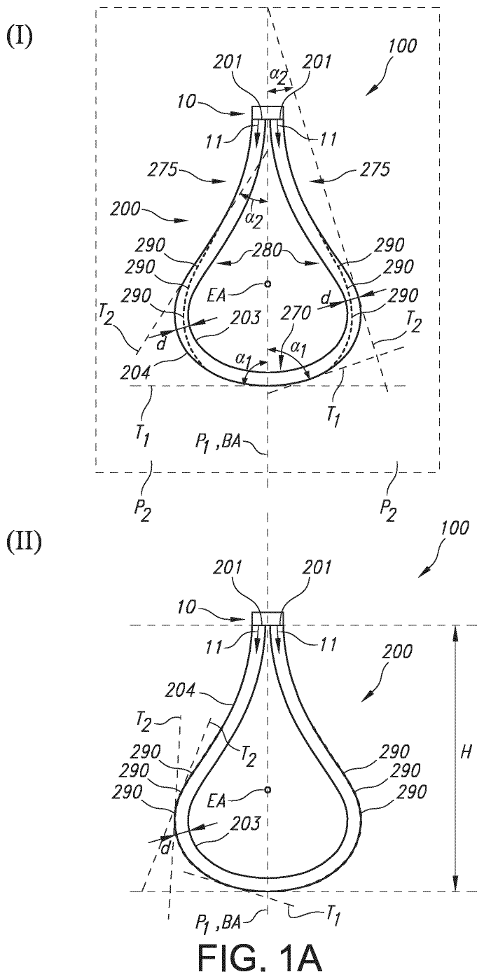

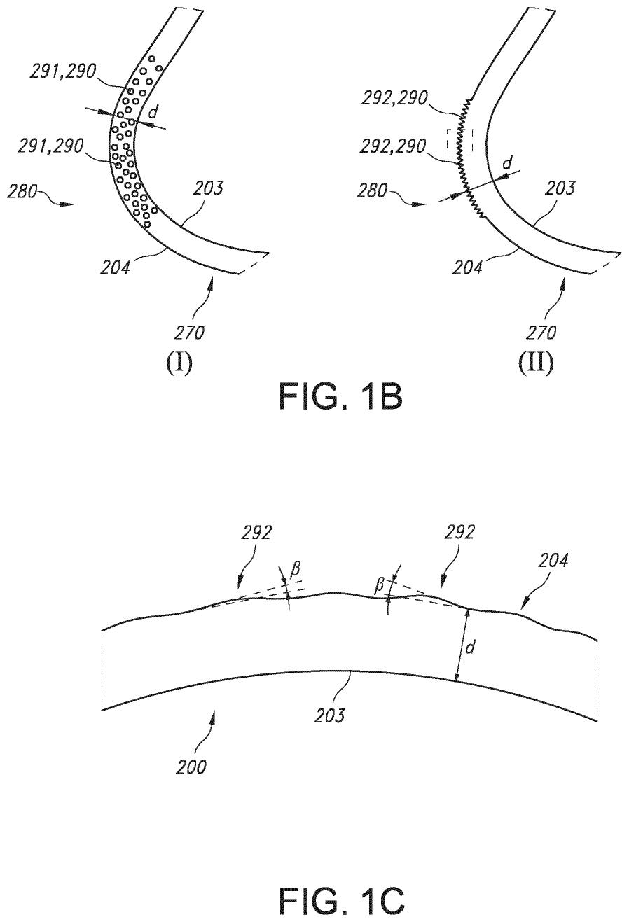

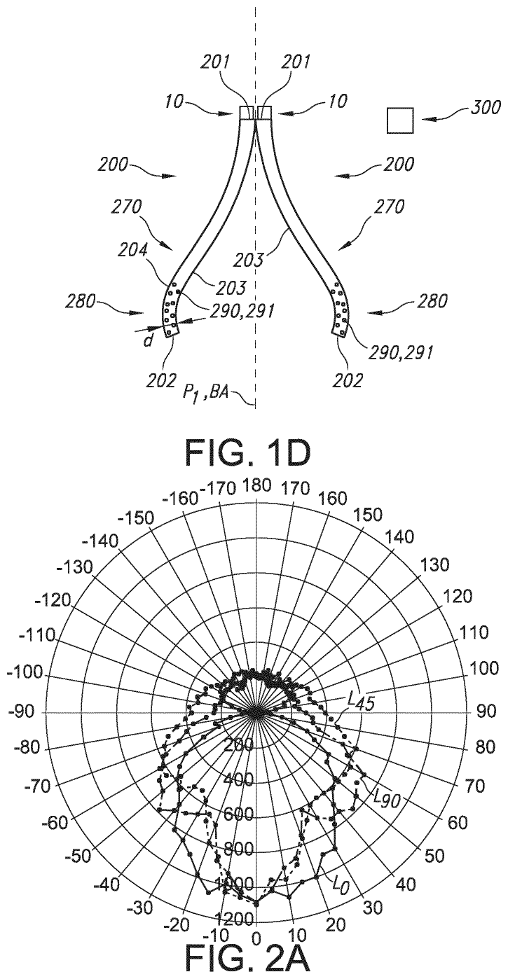

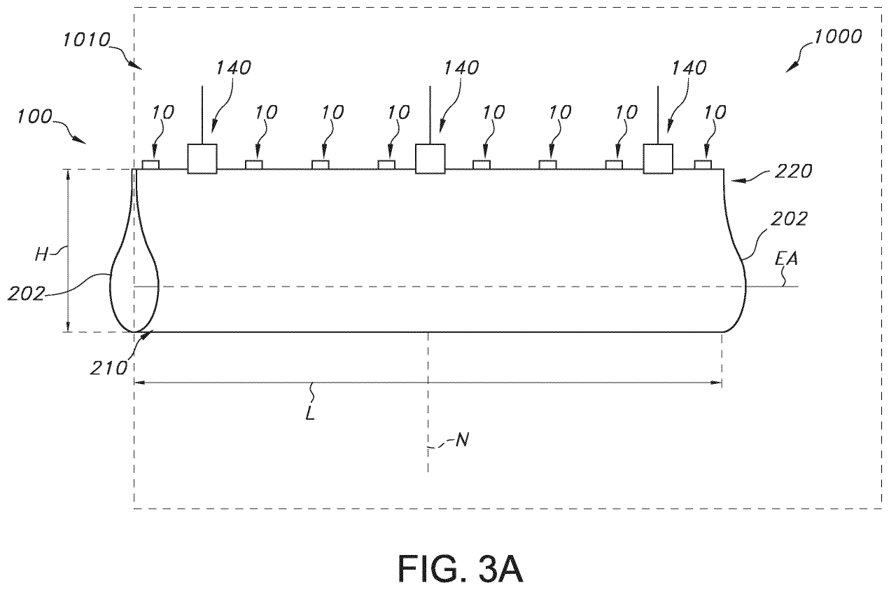

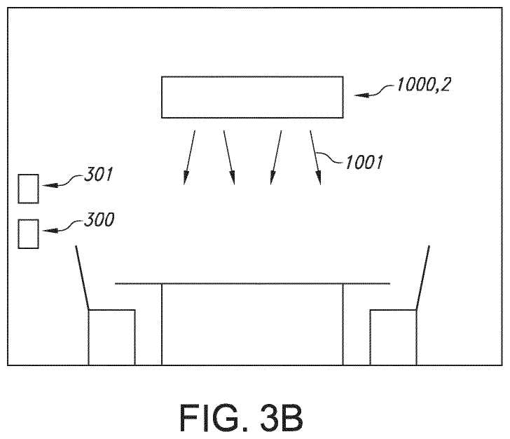

The light generating device and/or the elongated hollow body could have the feature that the elongated hollow body is resilient, for example in that it is made of resilient material and/or has a shape suitable for acting as a spring, for example a loop-like shape, and wherein the elongated hollow body at its second end rests with a pressing force against the fixation element. Depending on the configuration, the fixation element is forcing the terminal edges towards each other (for example as shown in FIG. 1J) or forcing away from each other (for example as shown in FIG. 3). This renders the outcoupling unit to have the advantage of an enhanced grip of the fixation element on the elongated hollow body, hence a more reliable connection between elongated hollow body and fixation element. This, for example, is convenient in case the fixation element simultaneously functions as a suspension element of the luminaire. Furthermore, in the case that due to the resiliency the terminal edges are inclined to bend away from each other, an optical gap between the two terminal edges can easily (automatically) be maintained, which reduces the risk on scattering of light coupled in via the terminal edges into the elongated hollow body.

In embodiments, the fixation may comprise a grip around the second end. The grip may be configured for suspension, for instance by comprising or by functionally coupling to a means for suspending. The fixation element may thus be used to keep the two terminal edges close or even pressed to each other. The fixation element may further be used for e.g. suspension. For instance, the fixation element may comprise means for suspension or may be configured to be functionally coupled to means for suspension. This may especially apply to mechanical fixation elements. The term “fixation” element may also refer to a plurality of (different) fixation elements.

In embodiments, the shortest distance between the two edges may be essentially zero (mm).

The light generating device may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, etc. As indicated above, the light generating device may be comprised by a luminaire. In embodiments, the support may comprise the fixation element. Or, alternatively, in embodiments the fixation element may comprise the support. In yet further embodiments, the support and the light generating device are configured for a suspended configuration of the light generating device.

In yet a further aspect, the invention also provides an office lighting system comprising a luminaire comprising (a) the light generating device as defined herein.

In embodiments, the shape of the light guide and of the reduced thickness part(s) are selected to provide a Unified Glare Rating (UGR) of at maximum 19. The UGR is known to a person skilled in the art, and may e.g. be determined according to CIE 117-1995, Discomfort Glare In Interior Lighting, http://www.cie.co.at/publications/discomfort-glare-interior-lighting.

The elongated hollow body may be provided in different ways. Relatively simple embodiments are embodiments wherein a plate-like or sheet-like light guide is bent and the two terminal edges are fixated with the fixation element. The light guide may in this way spontaneously form the piriform-like shape. Alternatively, the curved light guide may be provided via e.g. extrusion. Even the, two terminal edges may be provided, that are fixated with the fixation element. This appears to be better than extruding a body wherein the terminal edges are a single terminal element (i.e. a hollow body also closed at the terminal edges is created by extrusion), as this may lead to some scattering at the split.

### BRIEF DESCRIPTION OF THE DRAWINGS

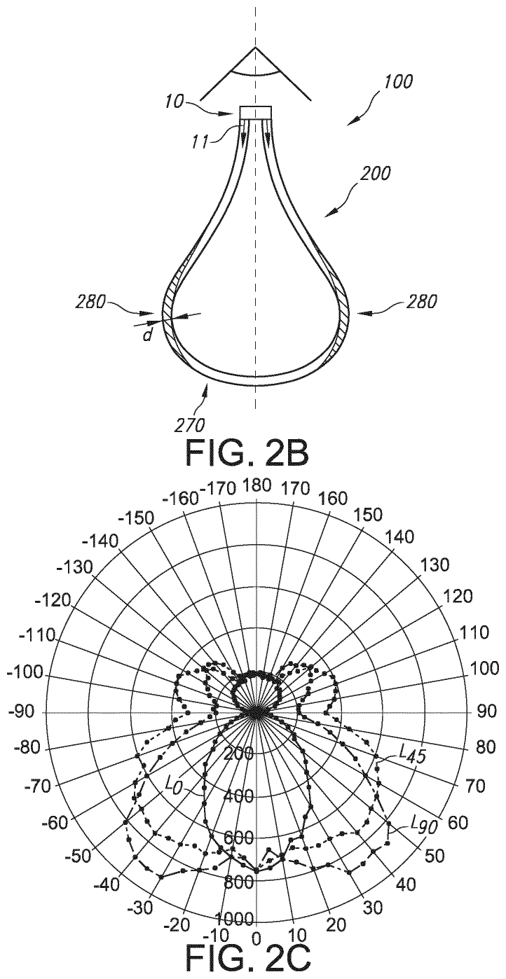

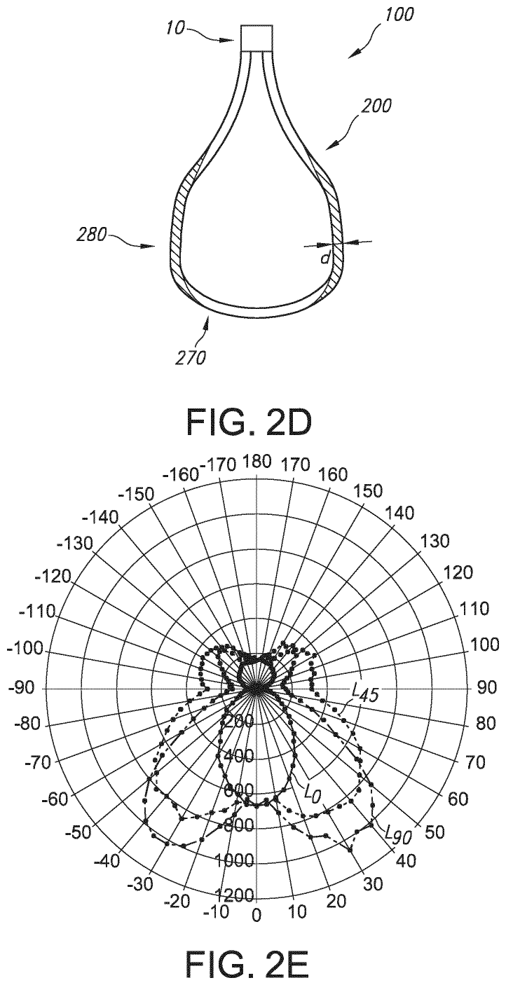

Embodiments of the invention will now be described, by way of example only, with reference to the accompanying schematic drawings in which corresponding reference symbols indicate corresponding parts, and in which: FIGS. 1a-1d schematically depict some aspects and embodiments of a light generating device; FIGS. 2a-2e schematically depict some of the simulation results; and FIGS. 3a-3b schematically depicts some embodiments and further aspects. The schematic drawings are not necessarily to scale.

### DETAILED DESCRIPTION OF THE EMBODIMENTS

FIG. 1a schematically depicts an embodiment of a light generating device 100 comprising a light source 10 and a sheet-like light guide 200. Especially, the light source 10 is configured to generate visible light 11. The light source 10 may especially comprise a solid state light source, like a LED. In embodiments, the light source light 10 may be divergent, like an opening angle (FWHM of intensity) of at least 10°, especially in embodiments in the plane of the light (see e.g. FIG. 3a). However, the light source light 10 may also be (pre)collimated. FIG. 1a especially provides two cross-sectional views of two different embodiments. The plane of drawing is the same plane as a second plane P2 (see also below). A first plane P1 (see also below), is perpendicular to the plane of drawing. Hence, the embodiments schematically depicted may be rotationally symmetric around a body axis BA. Hence, in embodiments the sheet-like light guide 200 has a body axis BA around which the sheet-like light guide 200 is rotational symmetrically configured. This may in embodiments provide a bulb-like shape. Alternatively, in embodiments the sheet-like light guide 200 has an elongated shape having the first plane P1 as plane of symmetry. Especially, in embodiments the sheet-like light guide 200 may have a piriform-like shaped cross-section with the second plane P2. This may thus be rotational symmetrically configured around the body axis BA or this may be an elongated sheet-like light guide 200, which is elongated along an axis of elongation EA (perpendicular to the plane of drawing).

As schematically depicted in FIG. 1a, the light guide 200 may especially be defined by the two terminal edges 201, a first face 203, and a second face 204. The first face 203, in these embodiments, is an internal face; the second face 204, in these embodiments, is an external face. Hence, the sheet-like light guide 200 may have a first edge 201, configured in a light receiving relationship with the light source 10. Here, both first edges 201 are configured in a light receiving relationship with the light source 10. In alternative embodiments, each first edge 201 may be in a light receiving relationship with a different light source 10.

As very schematically depicted, the sheet-like light guide 200 comprises light outcoupling structures 290. FIG. 1a (and also FIG. 1b) schematically depicts two possible embodiments of the light outcoupling structures 290. On the left (I), essentially bulk light outcoupling structures 290 are depicted, and on the right (II), essentially surface light outcoupling structures 290 are depicted.

Especially, the sheet-like light guide 200 and the light source 10 are configured such that part of the light source light 11 propagates through the sheet-like light guide 200, and at least part of the light propagating through the sheet-like light guide 200 escapes from the sheet-like light guide 200 via the light outcoupling structures 290. Especially, due to total internal reflection light source light 11 propagates from the light source through a part essentially without light outcoupling structures 290, and then propagates into the second part 280, wherein essentially all light outcoupling structures 290 may be located. Here, light source light 11 is outcoupled. Most light source light 11 may be outcoupled and may thereby not reach the first part 270 at all. Especially, the sheet-like light guide 200 comprises the afore-mentioned first part 270. Especially, this first part 270 has a first tangential T1 in a second plane P2 perpendicular to a first plane P1. The first tangential T1 has a first angle α1 with the first plane P1. In FIG. 1a, by way of example in embodiment I, it is schematically shown that that the first part 270 may have a plurality of first tangentials T1, which may comply with the conditions as herein defined for this first tangential T1. Further, especially the sheet-like light guide 200 comprises the afore-mentioned second part 280. Especially, the second part 280 has a second tangential T2 in the second plane P2 perpendicular to the first plane P1. Further, especially the second tangential T2 has a second angle α2 with the first plane P1. In FIG. 1a, by way of example in embodiment II, it is schematically shown that that the second part 280 may have a plurality of second tangentials T2, which may comply with the conditions as herein defined for this second tangential T2. As indicated above, especially the second part 280 comprises the light outcoupling structures 290. Hence, the first part 270 may essentially not comprise light outcoupling structures 290.

As schematically depicted, 60°≤α1≤90°, 0°≤α2≤60°, and α1>α2. Note that it is not excluded that there is a further second part essentially without light outcoupling structures 290. For instance, the part of the sheet-like light guide 200 close to the light source may comply with the (second) tangential condition of 0°≤α2≤60°, but does (essentially) not comprise light outcoupling structures. Such parts, complying with the conditions for the second tangential, but not comprising light outcoupling structures 290, are herein indicated with reference 275. Having no light outcoupling structures 290 close to the light source may reduce or prevent visibility of the light source.

Especially, essentially all light outcoupling may occur at the second part 280. However, there may also be some light outcoupling at the first part as not all light may be within the TIR conditions and as there may also be some imperfections in the first part 270. Hence, especially the light source 10, the sheet-like light guide 200 including the light outcoupling structures 290 are selected such, that a first luminance L1 from the first part 270 is equal to or lower than 1000 cd/m² (when viewed from any direction) and a second luminance L2 from the second part 280 is at least 2000 cd/m² (when viewed from least one viewing direction). Especially, the first luminance L1 from the first part 270 may be selected from the range of 500-1000 cd/m² (when viewed from any direction).

The second part 280 with the light outcoupling structures 290 may comprise a substantial part of the total sheet-like light guide. In embodiments, the sheet-like light guide 200 has a total light guide volume V₀, wherein the first part 270 has a first volume V₁, wherein the second part 280 has a second volume V₂, wherein each of the first part 270 and the second part 280 have a volume of at least 20% of the total light guide volume V₀. Hence, essentially the total light guide volume V₀ may be defined by a length, a width, and a thickness d of the sheet-like light guide, assuming that the schematically depicted curved sheet-like light guide is based or could be based on a rectangular sheet-like light guide (which could be bent into the curved sheet-like light guide as schematically depicted).

FIG. 1a schematically depicts an embodiment (indicated with I) wherein the light outcoupling structures 290 comprise particles 291, wherein the particles 291 are embedded in the second part 280 of the sheet-like light guide 200. FIG. 1b schematically depicts a part therefor in more detail. Especially, the particles 291 may have volume averaged particle sizes selected from the range of 1.5-200 μm. Even more especially, at least 90 vol. % of the particles 291 have a particle size of at least 1 μm, such as at least 2 μm. FIG. 1a schematically also depicts an embodiment (indicated with II) wherein the sheet-like light guide 200 comprises a first face 203 and a second face 204, wherein the second face 204 comprises the light outcoupling structures 290. Especially, the light outcoupling structures 290 are comprised by a coating or wherein the light outcoupling structures 290 comprise surface structures comprised by the second face 204. The latter embodiment is very schematically depicted in embodiment II in FIG. 1b. FIG. 1c schematically depicts a part therefor in more detail (see II). Therefore, in embodiments the light guide may have global variations (the curvature of the light guide) and local variations (local deviations from a parallel orientation) on the light guide. As schematically depicted in FIG. 1a, at any position along the first part 270 first tangents T1 to the first part 270 in the second plane P2 may comply with 60°≤α1≤90°. Further, at any position along the second part 280 (comprising the light outcoupling structures 290) second tangents T2 to the second part 280 in the second plane P2 may comply with 0°≤|α2|≤60°, especially 0°≤α2≤45°.

Especially, the light outcoupling structures 290 are defined by surface variations 292 of the second face 204 of equal to or less than 10°. This is schematically depicted in more detail in FIG. 1c. Even more especially, in embodiments the light outcoupling structures 290 are defined by surface variations 292 of the second face 204 of equal to or less than 5°, such as even more especially equal to or less than 2°. Especially, the surface variations are defined by maximum surface variations 292 of the second face 204 of at least 0.5°, such as at least 1°. The surface variations may be defined with respect to a cross-sectional plane or with respect to a normal to a normal to the surface (such as especially to the first face). Reference d indicates the thickness of the sheet-like light guide 200

FIG. 1d schematically depicts an embodiment of the light generating device 100, wherein the device 100 comprises two sheet-like light guides 200. Each sheet-like light guide 200 has a first edge 201 and a second edge 202. Especially, the first edges 201 are closer to each other than to the second edges 202. Further, the second edges 202 are configured further away from each other than the first edges 201 are configured from each other. The (respective) first planes P1, perpendicular to the plane of drawing, may especially coincide. In specific embodiments, of which one is schematically depicted in FIG. 1d, the first planes P1 are planes of symmetry for the two sheet-like light guides 200. This thickness may be an average thickness in embodiments with relatively small surface variations 292. This may alternatively be described as:

A light generating device 100 comprising a light source 10 and a sheet-like light guide 200, wherein:

the light source 10 is configured to generate visible light 11;

the sheet-like light guide 200 has a first edge 201, configured in a light receiving relationship with the light source 10; wherein the sheet-like light guide 200 comprises light outcoupling structures 290; wherein the sheet-like light guide 200 and the light source 10 are configured such that part of the light source light 11 propagates through the sheet-like light guide 200, and at least part of the light propagating through the sheet-like light guide 200 escapes from the sheet-like light guide 200 via the light outcoupling structures 290;

the sheet-like light guide 200 comprises a third part 270 connected to the first edge and having a third tangential T3 in a second plane P2 configured perpendicular to a first plane P1, wherein the first tangential T3 has a third angle α3 with the first plane P1,

the sheet-like light guide comprises two second part 280 portions, connected via a respective third part portion 270 to said first edge, each second part having a second tangential T2 in the second plane P2 configured perpendicular to the first plane P1, wherein the second tangential T2 has a second angle α2 with the first plane P1; wherein optionally only the second part 280 comprises the light outcoupling structures 290; and −60°≤α2≤60° and 0°≤α3≤60°. Typically, the third part portions mutually taper away in a direction from the first edges to the second part portions, such that the second part portions are spaced from each other by a spacing of at least five times the thickness d of the sheet-like light guide, for example at least ten times said thickness d, such as at least twenty times thickness d. Furthermore, this light generating device 100 as described above may have the feature that at any position along the third part 270 third tangents T3 to the third part 270 in the second plane P2 comply with 0°≤α3≤60°, and wherein at any position along the second part 280 second tangents T2 to the second part 280 in the second plane P2 comply with 0°≤α2≤20°. Still furthermore, the spacing may at least partly be bridged by a first part extending from at least one of the second part portions. Even still furthermore, this light generating device 100 may have the feature that the two second part 280 portions are mutually connected via a first part 270 in between said two second part portions having a first tangential T1 in the second plane P2, wherein the first tangential T1 has a first angle α1 with the first plane P1, wherein 60°≤α1≤90° and α2≤α1, thus arriving at the embodiment as shown in FIG. 1A.

Reference 300 refers to a control system for controlling one or more of the one or more light sources 10.

Hence, FIGS. 1a-1d also schematically depict embodiments of a sheet-like light guide 200, wherein the sheet-like light guide 200 has a first edge 201, configurable in a light receiving relationship with a light source 10 configured to generate visible light source light 11. Especially, the sheet-like light guide 200 comprises light outcoupling structures 290. Further, especially the sheet-like light guide 200 is transmissive for at least part of the visible light source light 11 of the light source 10. In embodiments, the light outcoupling structures 290 are configured to facilitate escape of part of the light source light 11 propagating (due to total internal reflection) through the sheet-like light guide 200. Further, in embodiments the sheet-like light guide 200 comprises a first part 270 having a first tangential T1 in a second plane P2 perpendicular to a first plane P1, wherein the first tangential T1 has a first angle α1 with the first plane P1. Yet further, in embodiments the sheet-like light guide 200 comprises a second part 280 having a second tangential T2 in the second plane P2 perpendicular to the first plane P1, wherein the second tangential T2 has a second angle α2 with the first plane P1. Especially, the second part 280 comprises the light outcoupling structures 290. Further, as indicated above, in embodiments one or more of the following may apply: (a) 60°≤α1≤90°, (b) 0°≤α2≤60°, and (c) α1>α2.

FIG. 2a shows an angular power distribution of light generating devices such as schematically depicted in FIGS. 1a, but with a uniform distribution of scattering elements (over the light guide; hence no difference between a first part and a second part). Further, the sheet-like light guide 200 is elongated. Hence, a piriform-like light guide is applied. References L0, L45, and L90 refer to a plane parallel to P1, a plane under 45° with plane P1 and under 45° with Plane P2, and a parallel to P2, respectively.

FIG. 2b schematically depicts again embodiments as schematically depicted in FIGS. 1a and 1b). Also here, the sheet-like light guide 200 is elongated. Hence, a piriform-like light guide is applied. Angle γ may indicate an opening angle of the beam of device light generated by the device 100. Hence, reference γ may indicate the beam angle. The angular power distribution of such device 100 is depicted in FIG. 2c.

FIG. 2d shows a further embodiment, wherein the second part 280 is somewhat flattened. The inner shape, indicated with the dashed line, is flattened relative to the outer line, which has a more piriform like shape. Likewise, this may be done with the first part 270 or other parts. Also here, the sheet-like light guide 200 is elongated. Hence, a piriform-like light guide is applied. The angular power distribution thereof is shown in FIG. 2e.

FIG. 3a schematically depicts an embodiment of a luminaire 1000 comprising the light generating device 100 and a support 1010 for the light generating device 100. Here, by way of example the support 1010 and the light generating device 100 are configured for a suspended configuration of the light generating device 100. FIG. 3a schematically depicts an embodiment of the light generating device 100 with elongated sheet-like light guide 200. Further, FIG. 3a also schematically depicts an embodiment of a luminaire 1000 comprising the light generating device 100 and a support 1010 for the light generating device 100. For instance, the support 1010 and the light generating device 100 may be configured for a suspended configuration of the light generating device 100.

Referring to FIGS. 1a and 3a, in embodiments the light guide 200 may comprise two first terminal edges 201. As schematically depicted, in embodiments the terminal edges may thus be in contact with each other, thereby providing (at least part of) the narrow shaped body part. The sheet-like light guide 200 may have a body height H.

In embodiments, a fixation element 140 may be configured to releasably keep the first terminal edges 201 together. The fixation preferably is releasable, enabling a simple exchange of the curved light guide 200 to set another ratio between the amount of light coupled out from the first part and the second part, and/or change the beam shape as emitted by the light generating device. The light source 10 is configured to generate visible light, wherein at least one of the terminal edges 201 of the curved light guide 200 is configured in a light receiving relationship with the light source 10. Here, both the terminal edges 201 are configured in a light receiving relationship with the light source 10.

The sheet-like light guide 200 may have an axis of elongation EA. The sheet-like light guide 200 may have a piriform-like shape with a piriform-like shaped cross-section perpendicular to the axis of elongation EA.

Referring to FIGS. 1a and 3a, in embodiments the light guide 200 may especially be defined by the two terminal edges 201, two second edges 202, a first face 203, and a second face 204.

FIG. 3b schematically depicts an embodiment of a luminaire 2 comprising the light generating device 1000 as described above. Reference 301 indicates a user interface which may be functionally coupled with the control system 300 comprised by or functionally coupled to the lighting generating device 1000.

It appears that for very small particles, light may be strongly scattered in all directions, without a preference for the forward or backward direction. For larger particles, the light has a tendency to be scattered more in the forward direction (the initial direction of the light before scattering). In some of our examples, the light guide is made of clear PMMA with index 1.49, filled with scattering particles with index 2.5 and size 5 nm (strong scattering, symmetric forward and backward scattering), index 1.9 and size 200 nm (forward scattering limited within ˜0-40°), and index 1.42 and size 10000 nm (forward scattering limited within ˜1°). The scattering angle distribution by a single scattering event is based on a MIE scattering model. We noted that the intensity distribution resembles that of a Lambertian cylinder in case of strong scattering, but it becomes more downward emitting for forward scattering. In these (first) simulations, the scattering particle density was chosen such that the droplet is more-or-less evenly emitting (see also FIG. 2a). Although the beam shape becomes more suitable for indoor lighting, the amount of light sideways is still rather high and likely to cause glare. The intensity distribution may be improved considerably if the scattering is limited to segments of the light guide with a vertical orientation (see e.g. FIG. 2c). This intensity distribution is closer to the preferred delta or batwing shape often used in indoor lighting. In this embodiment, the vertically oriented segments were rather small, and the distribution is still affected by the (strong) curvature of the guide. A further improved intensity distribution may be obtained with light guides that have more flat vertically oriented segments (see FIG. 2d). Another design strategy is to use an elongated structure where almost all segments of the guide are essentially vertically oriented.

A plurality of simulations was executed. Amongst others, light extraction from a light guide of 3 mm thick, 100 mm long, based on PMMA with index 1.49, with volume scattering particles (index of refraction 1.54) was simulated. The following parameters were considered: peak angle, half peak angle, and efficiency.

The peak angle was defined as an angle of the peak intensity direction with respect to the light guide direction. A small angle may be desirable, because then the main direction of the extracted light follows the direction of the light guide. The half peak angle indicates the width of the extracted light beam. Smaller values may also be desirable. For a vertical orientation of the light guide, light beyond ˜60° is undesired, because it causes glare. For a somewhat curved or tilted light guide even more narrow beams may be desirable to avoid glare. The optimal efficiency of extraction along 100 mm guide may depend on the size of the total light guide. Especially, the total extraction may especially be ˜80-100% (from the luminous flux) along the complete light guide.

Assuming e.g. light extraction from a light guide with volume scattering particles of 3000 nm radius, the following data were generated:

| | peak | half peak | efficiency |
|---|---|---|---|
| volume fraction (%) | angle (°) | angle (°) | (%) |
| 0.0013 | 15 | 35 | 0.23 |
| 0.013 | 15 | 26 | 4.3 |
| 0.065 | 15 | 32 | 25 |
| 0.13 | 20 | 36 | 43 |
| 0.39 | 25 | 46 | 76 |
| 0.78 | 30 | 56 | 87 |
| 1.3 | 35 | 68 | 90 |
| 2.6 | 40 | 85 | 90 |

At “ideal” volume fraction 4R/3d=0.13% the peak angle is 20° and the half peak angle is 36°, which are both good small values. Note that here the radius (and not the diameter) is chosen. The extraction efficiency along 100 mm guide is 43%, so this is perfect for a 200-300 mm long light guide. For different lengths of the light guide, volume fraction may be tuned in the range of ˜0.013%-1.3% although the beam at volume fractions above ˜1% starts to have too much glaring light at angles >60°.

Assume light extraction from a light guide with volume scattering particles of 10000 nm radius, the following data were generated:

| | peak | half peak | efficiency |
|---|---|---|---|
| volume fraction (%) | angle (°) | angle (°) | (%) |
| 0.022 | 15 | 32 | 2.7 |
| 0.044 | 15 | 32 | 6 |
| 0.22 | 20 | 35 | 32 |
| 0.44 | 20 | 40 | 53 |
| 1.32 | 27 | 52 | 83 |
| 2.64 | 30 | 64 | 89 |
| 4.4 | 40 | 74 | 90 |

Behavior is similar to that of 3000 nm particles, but shifted to higher volume fractions. At “ideal” volume fraction 4R/3d=0.44% the peak angle is 20° and the half peak angle is 40°, which are both good small values. Note that here the radius (and not the diameter) is chosen. The extraction efficiency along 100 mm guide is 53%, so this is perfect for a 150-250 mm long light guide. For different lengths of the light guide, volume fraction may be tuned in the range of ˜0.04%-4% although the beam at volume fractions above ˜2% starts to have too much glaring light at angles >60°.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” includes also embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

Hence, amongst others the invention provides in embodiments forward scattering extraction features (to enable directional output in combination with a soft appearance) that are especially concentrated in a vertically oriented segment of the curved light guide.

1. A light generating device comprising a light source and a sheet-like light guide, wherein:
the light source is configured to generate visible light;
the sheet-like light guide has a first edge, configured in a light receiving relationship with the light source; wherein the sheet-like light guide comprises light outcoupling structures; wherein the sheet-like light guide and the light source are configured such that part of the light source light propagates through the sheet-like light guide, and at least part of the light propagating through the sheet-like light guide escapes from the sheet-like light guide via the light outcoupling structures;
the sheet-like light guide comprises a first part having a first tangential in a second plane configured perpendicular to a first plane, wherein the first tangential has a first angle with the first plane;
the sheet-like light guide comprises a second part having a second tangential in the second plane, wherein the second tangential has a second angle with the first plane; wherein the second part comprises the light outcoupling structures in a second average outcoupling structure density C2, and wherein the first part has a first average outcoupling structure density C1, wherein 0<C1/C2≤0.1; and
60°≤α1≤90°, 0°≤α2≤60°, and α1>α2, and
wherein the sheet-like light guide has a light guide thickness d, wherein at least 90 vol. % of the particles have a particle size of at maximum 0.1*d, wherein a volume fraction ϕ of the particles is selected from the range of 0.1*(⅔)*D1/d≤ϕ≤10*(⅔)*D1/d.

2. The light generating device according to claim 1, wherein the outcoupling structures are defined by surface variations.

3. The light generating device according to claim 1, wherein the light source, the sheet-like light guide including the light outcoupling structures are selected such, that a first luminance L1 from the first part is equal to or lower than 1000 cd/m² when viewed from any direction, and a second luminance L2 from the second part is at least 2000 cd/m², when viewed from least one viewing direction.

4. The light generating device according to claim 1, wherein the sheet-like light guide has a total light guide volume V₀, wherein the first part has a first volume V₁, and wherein the second part has a second volume V₂, wherein each of the first part and the second part have a volume of at least 20% of the total light guide volume V₀; wherein at any position along the first part first tangents to the first part in the second plane (P2) comply with 60°≤α1≤90°, and wherein at any position along the second part second tangents to the second part in the second plane comply with 0°≤α2≤20°.

5. The light generating device according to claim 1, wherein the light outcoupling structures comprise particles, wherein the particles are embedded in the second part of the sheet-like light guide, wherein the particles have volume averaged particle sizes selected from the range of 1.5-200 μm.

6. The light generating device according to claim 1, wherein the sheet-like light guide has a light guide thickness d, wherein at least 90 vol. % of the particles have a particle size of at least 3000 nm radius and at maximum 0.1*d, wherein a volume fraction ϕ of the particles is selected from the range of 0.1*(⅔)*D1/d≤ϕ≤1*(⅔)*D1/d.

7. The light generating device according to claim 1, wherein the sheet-like light guide comprises a first face and a second face, wherein the second face comprises the light outcoupling structures.

8. The light generating device according to claim 6, wherein the light outcoupling structures are defined by surface variations of the second face of equal to or less than 10°, wherein one or more of the light outcoupling structures have maximum surface variations equal to or more than 0.5°, and wherein each surface variation comprises a first part that bends away from an average surface and a second part that bends towards the average surface.

9. The light generating device according to claim 6, wherein a cross-section of the second face and the second P2 has a corrugated shape defined by the surface variations, with in the range of 0.5-100 surface variations per cm of the cross-section.

10. The light generating device according to claim 1, wherein the sheet-like light guide has a body axis (BA) around which the sheet-like light guide is rotational symmetrically configured.

11. The light generating device according to claim 1, wherein the sheet-like light guide has an elongated shape having the first plane as plane of symmetry, and wherein the sheet-like light guide has piriform-like shaped cross-section with the second plane.

12. The light generating device according to claim 1, comprising two sheet-like light guides, wherein each sheet-like light guide has a first edge and a second edge, wherein the first edges are closer to each other than to the second edges, and wherein the second edges are configured further away from each other than the first edges are configured from each other, and wherein the first planes coincide, and wherein the first planes are planes of symmetry for the two sheet-like light guides.

13. A luminaire comprising (a) the light generating device according to claim 1, and (b) a support for the light generating device.

14. The luminaire according to claim 13, wherein the support and the light generating device are configured for a suspended configuration of the light generating device.

15. A sheet-like light guide, wherein:
the sheet-like light guide has a first edge, configurable in a light receiving relationship with a light source configured to generate visible light source light; wherein the sheet-like light guide comprises light outcoupling structures; wherein the sheet-like light guide is transmissive for at least part of the visible light source light of the light source; wherein the light outcoupling structures are configured to facilitate escape of part of the light source light propagating through the sheet-like light guide;
the sheet-like light guide comprises a first part having a first tangential in a second plane perpendicular to a first plane, wherein the first tangential has a first angle with the first plane;
the sheet-like light guide comprises a second part having a second tangential in the second plane, wherein the second tangential has a second angle with the first plane; wherein the second part comprises the light outcoupling structures in a second average outcoupling structure density C2, and wherein the first part has a first average outcoupling structure density C1, wherein 0<C1/C2≤0.1;
60°≤α1≤90°, 0°≤α2≤60°, and α1>α2, and
wherein the sheet-like light guide has a light guide thickness d, wherein at least 90 vol. % of the particles have a particle size (D1) of at maximum 0.1*d, wherein a volume fraction ϕ of the particles is selected from the range of 0.1*(⅔)*D1/d≤ϕ≤10*(⅔)*D1/d.
